(19) United States
(12) Patent Application Publication
(10) Pub. No.: US 2003/0058223 A1
(43) Pub. Date: Mar. 27, 2003

(54) Adaptable keypad and button mechanism therefor

(76) Inventors: James L. Tracy, Coral Springs, FL (US); James A. Zollo, Weston, FL (US); Bharat N. Vakil, Coral Springs, FL (US)

Correspondence Address: Scott M. Garrett, Motorola, Inc., Law Department, 8000 West Sunrise Boulevard, Fort Lauderdale, FL, 33322, US

(21) Appl. No.: 10/055,474

(22) Filed: Jan. 23, 2002

Related U.S. Application Data
(60) Provisional application No. 60/324,146, filed on Sep. 21, 2001.

(51) Int. Cl. G09G 5/00

(52) U.S. Cl. 345/169

(57) ABSTRACT

An adaptable keypad or button utilizes a display laminate made up of a driving layer (108), an electrically active ink layer (110), and a transparent conductor layer (112). In a preferred embodiment, the display laminate is placed between a switch (302, 303, 304) and an actuating member. The driving layer has a series of symbols or characters created by conductor patterns (202, 204, 208, 210) in the shape of the symbols or characters. Some of the conductor segments are used exclusively by one character, some are used exclusively by another character, and some may be common to both characters. The conductors making up the desired character or symbol to be displayed are electrically energized, causing a corresponding pattern in the electrically active ink layer to appear. If the character or symbol needs to be changed to the alternate symbol on the button, then the first character image is erased from the active ink, and the second conductor set is electrically energized to form an image of the second character in the active ink.

### CROSS REFERENCE TO RELATED APPLICATIONS

This application claims the benefit of U.S. Provisional Application No. 60/324,146 filed Sep. 21, 2001 and assigned to Motorola, Inc.

### TECHNICAL FIELD

This invention relates in general to user interface devices, and more particularly to keypads and buttons for use with devices where the keypad or button can be used for more than one mode of operation.

### BACKGROUND OF THE INVENTION

Electronic devices are in widespread use throughout the world, and portable electronic devices such as cellular radio telephones and personal data organizers are also used in increasing frequency. In many instances people may have several of these devices for performing different tasks. From a user's perspective, it would be much more convenient to have such devices integrated into one device. Integration would eliminate having to maintain separate accessories, batteries, and so on, and carrying one device is more convenient than carrying several devices for separate functions. One problem that has arisen in considering ways to integrate such devices into one device is the ergonomics of the user interface. For example, users have come to expect a cellular radio telephone to have a numeric keypad, with several alphabetic characters available on the digit keys for text entry. Conversely, users of so called two-way pagers and palm-top computers are accustomed to more conventional “QWERTY” keypads, having a layout similar to that of a computer keyboard and typewriters.

Manufacturers of electronic devices often manufacture the devices for sale in more than one world market, and consequently often have different keypads or buttons made with language or characters corresponding to the language prevalent in a particular region. This necessitates having an inventory of different parts for keypads and button, as well as maintaining separate “kits” for tracking the devices once they are assembled to assure the right kit goes to the intended market.

It would be of substantial benefit if, on an integrated device that performs several functions, the keypad and buttons could adapt, and change their appearance, so as to provide a familiar interface to the user. Similarly, if a keypad or button could change it's appearance, then the same keypad could be used for different language markets, and it would simply display the appropriate characters or symbols. That is, if the keypad was adaptable, a common keypad sub-assembly could be used, thereby eliminating the need for inventorying different keypad parts for different language markets. Having different characters or symbols displayed on various keys or buttons would be possible using conventional display technology, such as liquid crystal displays, one on each button. However this approach suffers from being prohibitively expensive, and LCD displays are not flexible, so they would not be optimal for use with popple switch type keypads commonly found on portable electronic device. Therefore there is a need for an adaptable keypad, and a need for button mechanisms for use therewith which is inexpensive and mechanically flexible.

### BRIEF DESCRIPTION OF THE DRAWINGS

FIG. 1 shows an exploded isometric view of an adaptable keypad assembly, in accordance with the invention;

FIG. 2 shows a detailed overhead view of coincident symbols formed by sets of conductor elements, in accordance with the invention;

FIG. 3 shows a side cross section view of a button mechanism, in accordance with the invention; and

FIG. 4 shows a side cross sectional view of an alternative button mechanism, in accordance with an alternative embodiment of the invention.

### DETAILED DESCRIPTION OF A PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward. A brief description of the prior art is also thought to be useful.

The invention provides an adaptable keypad and button mechanisms for use alone, or for providing an adaptable keypad when provided collectively. A button comprises a display means that allows more than one character or symbol to be displayed on the button. The display means is a laminate having a layer of electrically active ink between a driver layer and a transparent conductor layer. The driver layer has conductor elements in the form of various characters. More than one set of conductor elements forming different characters is coincidently located, and they may share common conductor elements where the characters or symbols overlap. Furthermore, the characters or symbols may be oriented differently so that different characters can be displayed in different orientations if used on a device having modes of operation using different orientations.

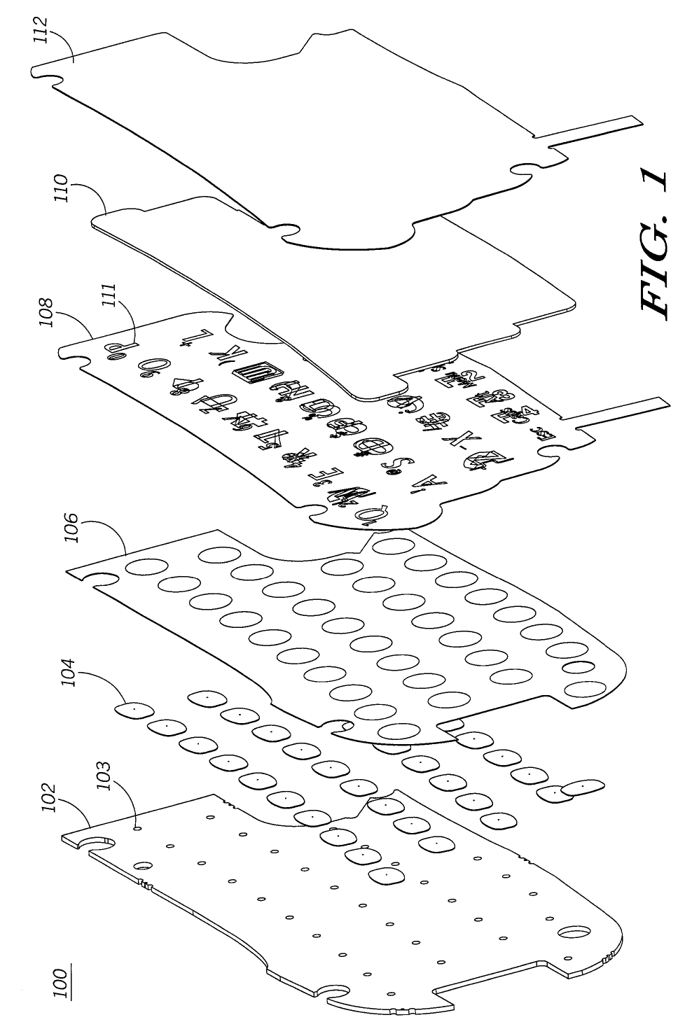

Referring now to FIG. 1, there is shown an exploded isometric view of an adaptable keypad assembly 100. The adaptable keypad assembly comprises a printed circuit board (PCB) 102 having a series of switch circuits 103 disposed thereon, a series of popple domes 104 aligned in correspondence with the switch circuits of the PCB, and an adhesive layer 106 for holding the popple domes in place. The assembly further includes a laminate for providing a display means comprised of a driver layer 108, an electrically active ink layer 110, and a transparent conductor layer 112. The driver layer 108 is itself a laminate comprised of a flexible insulator layer made of, for example, Mylar or polyamide. On the flexible insulator layer there is disposed conductor elements 114, such as copper or conductive ink, for example. The conductor elements form segments of characters or symbols to be displayed on a particular button or key of the adaptable keypad. There are also conductive traces connected to the conductive elements for providing voltage or otherwise electrically energizing the conductor elements. These traces may be on the same side of the flexible insulator, or they may be located on another side or inside the flexible substrate, and pass through the flexible insulator by, for example, plated via holes, as is known.

The electrically active ink layer is an electrophoretic material, and comprises, for example, bi-chromal microspheres having an electrical polarity, suspended in medium that allows the microspheres to freely rotate. An example of electrically active ink is shown in U.S. Pat. No. 6,120,588, assigned to E-Ink Corporation. The microspheres, being electrically polarized, rotate when a voltage differential is applied to them. Selectively applying voltage differential at various points on the layer causes the microspheres at those points to rotate, and being bi-chromal, show a different color at that point. The voltage differential is experienced between the conductor elements and the transparent conductor layer 112. The transparent conductor lay is a layer of, for example, indium tin oxide. The entire layer can be set to one voltage potential, while the conductor elements are set to a different voltage potential, thus creating an electric field between the transparent conductor layer and the conductor elements which will cause the bi-chromal polarized microspheres in the field to rotate accordingly. Initially all of the bi-chromal polarized microspheres will be commonly oriented. When the conductor elements and the transparent conductor layer are electrically energized, the spheres between them will rotate, causing the region of electrically active ink between the conductor elements and the transparent conductor layer to appear to change color in a pattern corresponding with the pattern of the conductor elements. Once rotated, the field can be removed, and the microspheres hold their orientation. To erase the pattern, a field having the opposite polarity is applied, causing the spheres to rotate to their initial position.

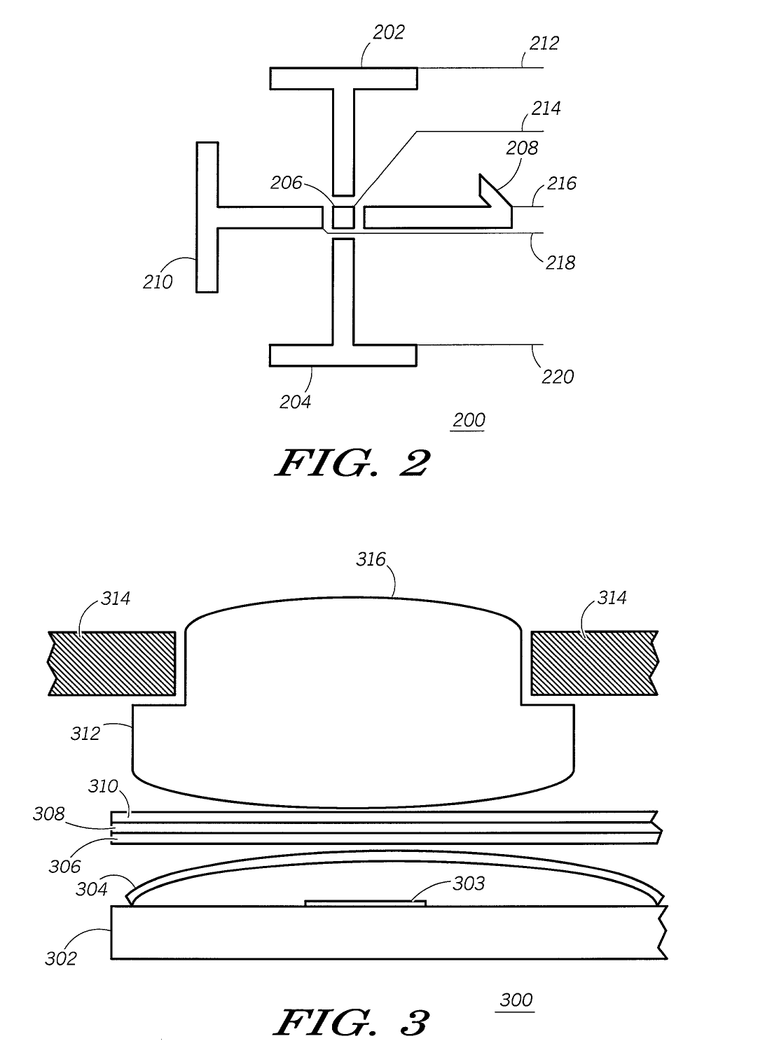

Referring now to FIG. 2, there is shown a detailed overhead view 200 of coincident symbols formed by sets of conductor elements on the flexible insulator layer of the driver layer 108. What is shown in FIG. 2 is a simple example of forming coincident characters or symbols. By coincident it is meant that the characters or symbols occupy a common region. They may be interleaved, as shown, or they may be proximately located so as to appear on the same key or button. It will be obvious to one of ordinary skill in the art that the teaching of the example can be extended to more complex characters and arrangements, as well as to more than two coincident characters or symbols. In the present example, a first set of conductor elements 202 and 204 form the English alphabetic character “I”. A second set of conductor elements 208 and 210 form an Arabic numeral “1” (one). Optionally, where the characters or symbols intersect, there may be a third set of conductor elements 206 which form segments common to both the first and second symbols. Similarly, a first set of conductive traces 212 and 220 connect to the conductor elements of the first set, a second set of conductive traces 216 and 218 connect to the second set of conductor elements, and a third set of conductor traces 214 connect to the common segments. Thus, when the first character is to be displayed, the first set of conductor elements are electrically energized as described hereinabove. In general, the various character sets are exclusively energized depending on a mode of operating the keypad or button. Of course, if one character is presently displayed when a different character is to be displayed, the presently displayed character must be erased.

In one embodiment of the invention, the characters or symbols are not commonly oriented as shown in FIG. 2. It is contemplated that the device utilizing the adaptable keypad is operable in a variety of modes, where the keypad may be used in a “landscape” mode as a text entry keypad, and in a “portrait” mode where the keypad may be used, for example, as a telephone keypad. An example of such a device can be found in U.S. patent application Ser. No. 09/560,977, titled “Self-Configuring Multiple Element Portable Electronic Device,” and which is assigned to the present assignee. Of course, the coincident characters or symbols may be commonly oriented, as will be the case when characters for different languages are used on the keypad or button, which allows the user to display a preferred character language set, where all the keys or buttons show characters for a particular language.

Referring now to FIG. 3, there is shown a side cross-sectional view of a button mechanism 300, in accordance with the invention. The button mechanism shown here is compatible with the keypad assembly shown in FIG. 1. This particular embodiment of a button mechanism utilizes a printed circuit board (PCB) 302 and popple switch 304 design, as is common. The PCB is a conventionally fabricated PCB, and has on a switch circuit, which is a conductor that is electrically connected to control circuitry for detecting when the popple switch 304 comes into contact with the switch circuit. The popple switch is a dome structure fabricated of electrically conductive material. Then the popple dome is depressed, it comes into contact with the switch circuit and completes a circuit, which is detected by control circuitry, as is conventional. Disposed in correspondence with the switch means is the display means, comprised of the driver layer 306, the electrically active ink layer 308, and the transparent conductor layer 310. The electrically active ink layer is disposed between the driver layer and transparent conductor layer. This display laminate is flexible, allowing the popple dome to be depressed. The button mechanism could function with just the display laminate and popple switch, but in the preferred embodiment, the button mechanism further comprises a transparent actuating member 312 disposed in correspondence with the popple switch, such that the display means is between the popple switch and the transparent actuating member. The transparent actuating member contacts the display laminate and is held in place by the housing 314 of the device in which the button is situated. Lastly, it is contemplated that the transparent actuating member has a convex outer surface 316 to provide a magnifying effect, as well as tactile differentiation from the device housing.

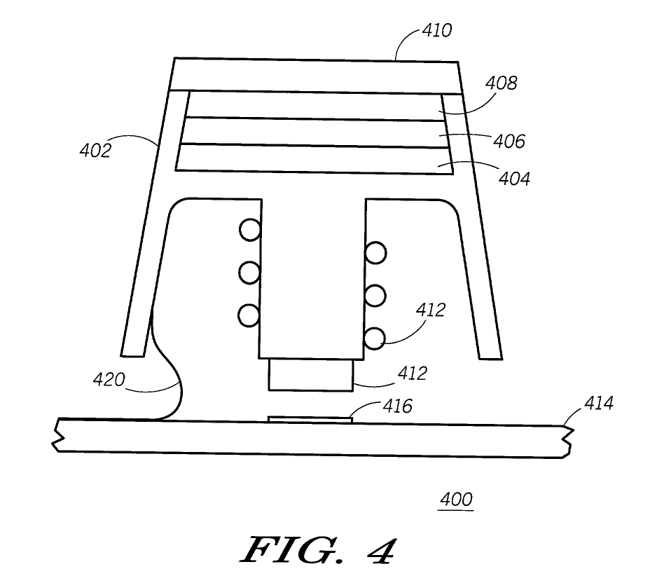

Referring now to FIG. 4, there is shown a side cross sectional view of an alternative button mechanism 400, in accordance with an alternative embodiment of the invention. In this embodiment an alternative switch means is shown which is more compatible with a standard keyboard, such as those commonly used with computer terminals. The button or key comprises a body 402 that will typically be made of molded plastic. A display laminate resides within a recess formed on top of the button body, and includes the driver layer 404, electrically active ink layer 406, and transparent conductor layer 408. On top of the display laminate a transparent cover 410 may be disposed to preserve the display laminate. The button mechanism body is biased by a spring means 412, away from, for example, a PCB 414. A switch circuit 416 is disposed on the PCB under the button body. A conductive member 418 is disposed on a lower portion of the button body, and corresponds to the switch circuit 416 so that when the button is depressed, it completes an electrical circuit, which is detected by control circuitry. To drive the display, a flexible connector 420 is used to connect control circuitry to the driver layer and transparent conductor layer of the display laminate. Thus, a keyboard can be made with a collection of button mechanisms like this, each button can have several characters formed on the driver layer of its respective driving layer portion, each character belonging to a different language set. When the user wishes the keyboard to show a different language character set, the control circuitry can erase the old characters and display new ones for the desired language.

Thus, the invention solves the problem of providing an adaptable keypad and button mechanism. While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A button mechanism, comprising:
a switch means for operating a button circuit in response to actuation of the button mechanism;
display means disposed in correspondence with the switch means and comprising:
a driver layer having a conductor pattern configured in the pattern of a symbol to be displayed on the button mechanism;
a transparent conductor layer; and
an electrically active ink layer disposed between the transparent conductor layer and the driver layer.

2. A button mechanism as defined in claim 1, wherein the conductor pattern comprises:
a first set of conductor elements corresponding to a first symbol; and
a second set of conductor elements corresponding to a second symbol;
wherein the first and second symbols are coincidentally located.

3. A button mechanism as defined in claim 2, further comprising a third set of conductor elements which form segments common to both the first and second symbols.

4. A button mechanism as defined in claim 2, wherein the first and second symbols are not commonly oriented.

5. A button mechanism as defined in claim 1, wherein the switch means comprises a popple switch.

6. A button mechanism as defined by claim 5, further comprising a transparent actuating member disposed in correspondence with the popple switch, such that the display means is between the popple switch and the transparent actuating member.

7. A button mechanism as defined in claim 6, wherein the transparent actuating member has a convex outer surface.

8. An adaptable keypad, comprising:
a plurality of keys, each of the plurality of keys comprising:
a switch means for operating a button circuit in response to actuation of the button mechanism;
display means disposed in correspondence with the switch means and comprising:
a driver layer having a conductor pattern configured in the pattern of a symbol to be displayed on the button mechanism;
a transparent conductor layer; and
an electrically active ink layer disposed between the transparent conductor layer and the driver layer.

9. An adaptable keypad as defined in claim 8, wherein the conductor pattern of each key comprises:
a first set of conductor elements corresponding to a first symbol; and
a second set of conductor elements corresponding to a second symbol;
wherein the first and second symbols are coincidentally located.

10. An adaptable keypad as defined in claim 9, each key further comprising a third set of conductor elements which form segments common to both the first and second symbols.

11. An adaptable keypad as defined in claim 9, wherein the first and second symbols are not commonly oriented.

12. An adaptable keypad as defined in claim 9, wherein the first set of conductor elements for each of the plurality of keys forms a first symbol set, the second set of conductor elements for each of the plurality of keys forms a second symbol set, the first and second symbol sets are exclusively energized depending on a mode of operating the keypad.

13. An adaptable keypad as defined in claim 8, wherein each of the switch means comprises a popple switch.

14. An adaptable keypad as defined by claim 13, further comprising a plurality of transparent actuating members, each of the transparent actuating members disposed in correspondence with each of the popple switches, such that the display means is between the popple switches and the transparent actuating members.

15. An adaptable keypad as defined in claim 13, wherein each of the transparent actuating members has a convex outer surface.

16. A portable electronic device having an adaptable keypad, the portable electronic device operable in a plurality of modes, the portable electronic device comprising:
a keypad having a plurality of keys comprising:
a switch means for operating a button circuit in response to actuation of the button mechanism;
display means disposed in correspondence with the switch means and comprising:
a driver layer having a conductor pattern configured in the pattern of a symbol to be displayed on the button mechanism, the conductor pattern including a first set of conductor elements corresponding to a first symbol, and a second set of conductor elements corresponding to a second symbol, and wherein the first and second symbols are coincidentally located;
a transparent conductor layer; and
an electrically active ink layer disposed between the transparent conductor layer and the driver layer.
